(19) United States
(12) Patent Application Publication
(10) Pub. No.: US 2016/0239474 A1
(43) Pub. Date: Aug. 18, 2016

(54) INFORMATION MANAGEMENT DEVICE AND INFORMATION MANAGEMENT METHOD

(71) Applicant: FUJITSU LIMITED, Kawasaki-shi (JP)

(72) Inventor: Fumihiro MARUYAMA, Hachioji (JP)

(73) Assignee: FUJITSU LIMITED, Kawasaki-shi (JP)

(21) Appl. No.: 14/987,846

(22) Filed: Jan. 5, 2016

(30) Foreign Application Priority Data
Feb. 12, 2015 (JP) 2015-025788

(51) Int. Cl. G06F 17/27; G06F 17/30

(52) U.S. Cl. CPC G06F 17/271; G06F 17/30477; G06F 17/274

(57) ABSTRACT

An information management device includes a memory and a processor coupled to the memory and configured to produce a second service process of a service which is defined by partial grammar by removing a first production rule out of a plurality production rules which are used by a first service process defined by context-free grammar, the first production rule being selected from among the plurality of production rules, and store process information associated with input information into the memory, the process information indicating a process included in the second service process.

### CROSS-REFERENCE TO RELATED APPLICATION

This application is based upon and claims the benefit of priority of the prior Japanese Patent Application No. 2015-025788, filed on Feb. 12, 2015, the entire contents of which are incorporated herein by reference.

### FIELD

The embodiment discussed herein is related to an information management technique.

### BACKGROUND

Various operational improvement techniques in order to improve productivity in the manufacturing industry have been proposed. In addition, for example, a process handbook which is able to define various activities using a hierarchical structure and searches information which is associated with the activity is proposed as an operational improvement technique which targets every activity that is included in the manufacturing industry. In recent years, there is a movement to apply the process handbook in order to improve productivity also in the service industry. In addition, representing an operation state of a body which is detected from image information using a case frame of case grammar and detecting the operation based on a rule set in advance is proposed. The related technique is disclosed in Japanese Unexamined Patent Application Publication No. 2009-199516.

### SUMMARY

According to an aspect of the invention, an information management device includes a memory and a processor coupled to the memory and configured to produce a second service process of a service which is defined by partial grammar by removing a first production rule out of a plurality production rules which are used by a first service process defined by context-free grammar, the first production rule being selected from among the plurality of production rules, and store process information associated with input information into the memory, the process information indicating a process included in the second service process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an information management device of an embodiment;

FIGS. 2A and 2B are diagrams which describe an example of the meaning of each process on a customer side;

FIGS. 3A and 3B are diagrams which describe an example of the meaning of each process on a provider side;

FIG. 4 is a diagram illustrating an example of a grammar memory unit;

FIG. 5 is a diagram illustrating an example of the grammar memory unit;

FIG. 6 is a diagram illustrating an example of a process information database;

FIG. 7 is a diagram illustrating an example of an attachment process memory unit;

FIG. 8 is a diagram illustrating an example of a partial grammar display screen;

FIG. 9 is a diagram illustrating another example of the partial grammar display screen;

FIG. 10 is a diagram illustrating another example of the partial grammar display screen;

FIG. 11 is a diagram illustrating another example of the partial grammar display screen;

FIG. 12 is a diagram illustrating another example of the partial grammar display screen;

FIG. 13 is a diagram illustrating an example of an attachment process;

FIG. 14 is a diagram illustrating another example of the partial grammar display screen;

FIG. 15 is a diagram illustrating another example of the partial grammar display screen;

FIG. 16 is a diagram illustrating another example of the partial grammar display screen;

FIG. 17 is a diagram illustrating another example of the partial grammar display screen;

FIG. 18 is a diagram illustrating another example of the partial grammar display screen;

FIG. 19 is a diagram illustrating another example of the partial grammar display screen;

FIG. 20 is a diagram illustrating another example of the partial grammar display screen;

FIG. 21 is a diagram illustrating another example of the partial grammar display screen;

FIG. 22 is a diagram illustrating another example of the partial grammar display screen;

FIG. 23 is a diagram illustrating another example of the partial grammar display screen;

FIG. 24 is a diagram illustrating another example of the partial grammar display screen;

FIG. 25 is a diagram illustrating another example of the partial grammar display screen;

FIG. 26 is a flow chart illustrating an example of a specialized service process grammar production process;

FIG. 27 is a flow chart illustrating an example of an information storage process;

FIG. 28 is a flow chart illustrating an example of a search process; and

FIG. 29 is a diagram illustrating an example of a computer which executes an information management program.

### DESCRIPTION OF EMBODIMENT

In service industries, there are cases where information is associated with a process flow as a series of activities, and cases where the activity is repeatedly performed, but it is difficult to represent information of the process flow and repetition of the activity in only information which is associated with the activity. In addition, it is difficult to handle a process flow using case grammar, that is, a time series process. Thereby, it is difficult to search service information including repetition of flow process information or an activity, that is, a time series process.

In one aspect, the technique of the disclosure in the embodiment has the object of searching for service information which includes a time series process.

With reference to the drawings an embodiment of an information management device, an information management method, and an information management program which is a disclosure of the present application will be described below in detail. Here, the techniques of the disclosure are not limited by the embodiment. In addition, the embodiment described below may be appropriately combined within a range which is not inconsistent.

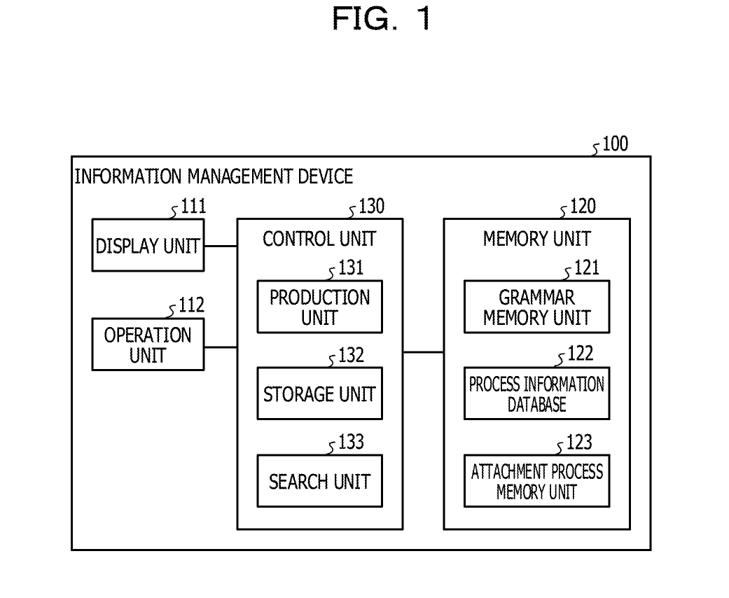

FIG. 1 is a block diagram illustrating an example of a configuration of an information management device of the embodiment. An information management device 100 which is illustrated in FIG. 1 displays a first service process which is defined by a process of a service with context-free grammar. Here, in the description below, the first service process which is defined by a process of a service with context-free grammar will also be expressed as generalized service process grammar. The information management device 100 produces a second service process which includes a production rule which corresponds to a service which is selected from the production rules of the displayed first service process, and corresponds to the service. That is, the information management device 100 produces the second service process which includes the process that is included in the selected service. Here, in the description below, the second service process will also be expressed as specialized service process grammar (hereinafter, partial grammar). The information management device 100 stores the produced second service process in the grammar memory unit.

The information management device 100 associates information in the process that is included in the produced second service process to store in a process information database (hereinafter, database is represented by DB). That is, for example, the information management device 100 associates information of the process flow in various service industries with specialized service process grammar which represents the respective services to store in a process information DB. For example, concerning “need recognition” on a side of a customer who receives a service, the information management device 100 associates information on X service “search need recognition” and Y service “haircut need recognition” with partial grammar which represents the respective services to store in the process information DB.

The information management device 100 searches the process information DB using a character string which specifies the process that is included in the first service process. For example, the information management device 100 searches the process information DB using “recognize (need recognition)” as the character string (vocabulary of the service process grammar) which specifies the process that is included in the first service process. As a search result, for example, the information management device 100 displays information which is stored to be associated with “search need recognition” and “haircut need recognition” as the search result. Thereby, the information management device 100 is able to search information on various services which include a time series process using general vocabulary.

Here, the first service process, that is, the generalized service process grammar generalizes the service process and expresses the service process using vocabulary which is as general as possible. The generalized service process grammar includes a process which represents an operation on the customer side, and a process which represents an operation on the provider side. In addition, the customer side process and the provider side process are described using context-free grammar, and include a portion which is attached between both processes. In addition, the individual service processes are described using partial grammar which is specialized grammar of the generalized service process.

Here, the context-free grammar will be described. The context-free grammar is grammar which is used in linguistics and information engineering, and all production rules are expressed in the form of “V→w”. In the production rules, V indicates a nonterminal symbol, and for example, indicates a sentence, a noun phrase, or a verb phrase. In addition, in the production rules, w indicates a character string which is configured by terminal symbols and nonterminal symbols. For example, the terminal symbols indicate a word or the like. In the production rule, when V appears, it is possible to replace V with w.

The context-free grammar starts from a special variable which is referred to as a start symbol S, and finally it is possible to develop a string of a terminal symbol, that is, a grammatically correct sentence. For example, the context-free grammar in which an expression of four arithmetic operations which are grammatically correct that use three types of variables x, y, and z are produced is able to be expressed below as equation (1).

S→x|y|z|S+S|S−S|S*S|S/S|(S) (1)

In Equation (1), eight production rules are represented at once using a logical sum (|). That is, in Equation (1), the eight production rules “x”, “y”, “z”, “S+S”, “S−S”, “S*S”, “S/S”, and “(S)” are connected by the logical sum.

In addition, in a case where the context-free grammar is applied to the service process, a character string which is configured by symbols which are lined up represent a time series process in order from left to right. In a case where the generalized service process is defined using context-free grammar, for example, “S_{customer}” indicates the start symbol (variable) of the customer side process. In addition, for example, a character string which starts with an upper case letter indicates a nonterminal symbol (variable), and a character string with all lower case letters indicates a terminal symbol. In addition, ε indicates a space character string. Furthermore, for example, in a case where the same symbol (process name) is used on both the customer side and the provider side in the manner of “S_{customer}” and “S_{provider}”, each are distinguished by putting “_{customer}” and “_{provider}” in subscript.

Next, a configuration of the information management device 100 will be described. As indicated in FIG. 1, the information management device 100 has a display unit 111, an operation unit 112, a memory unit 120, and a control unit 130. Here, it does not matter even if the information management device 100 has various functional units which have a known computer other than the functional unit that is indicated in FIG. 1, for example, has a functional unit such as various input devices or audio output devices.

The display unit 111 is a display device for displaying all kinds of information. For example, the display unit 111 is realized by a liquid crystal display or the like as the display device. The display unit 111 displays various screens such a display screen of grammar which is input from the control unit 130 and a display screen of a search result.

The operation unit 112 is an input device which receives various operations from a user. For example, the operation unit 112 is realized by a keyboard, mouse, or the like as an input device. The operation unit 112 outputs the operation which is input by the user to the control unit 130 as the operation information. Here, the operation unit 112 may be realized by a touch panel or the like as the input device, and the display device of the display unit 111 and the input device of the operation unit 112 may be integrated.

For example, the memory unit 120 is realized by a storage device such as a semiconductor memory element such as a random access memory (RAM) or a flash memory, a hard disk, or an optical disc. The memory unit 120 has a grammar memory unit 121, a process information DB 122, and an attachment process memory unit 123. In addition, the memory unit 120 stores information which is used in a process by the control unit 130.

The grammar memory unit 121 stores generalized service process grammar and specialized service process grammar. Here, in the description below, in a case where the generalized service process grammar and the specialized service process grammar are not distinguished, the grammar is expressed. In addition, in the description below, each symbol also expresses a process.

Here, an example of the generalized service process grammar is indicated. First, the customer side processes are able to be indicated as follows.

S_{customer}→recognize Explore_provider Explore_item Consume

Settle_{customer} Attitude|recognize Explore_item
Explore_provider Consume Settle_{customer} Attitude

Explore_provider→select_provider|select_provider visit_provider|

abandon_provider|browse_provider Explore_provider|
search_provider Explore_provider|
get_estimate Explore_provider|ε

Explore_item→select_item|abandon_item|

browse_item Explore_item|search_item Explore_item|
get_estimate Explore_item|
sample_{customer} Explore_item|ε

Consume→Procure Appreciate|

Procure Appreciate Explore_item Consume|
Procure Appreciate Explore_provider Consume|
Procure Appreciate Explore_provider Explore_item Consume|
Procure Appreciate Explore_item Explore_provider Consume|ε

Procure→reserve|pay|place_order|

contract_{customer}|request|reserve Procure|pay Procure
|place_order Procure|contract_{customer} Procure|
request Procure

Appreciate→receive_item Evaluate|prepare_{customer} receive_item

Evaluate|receive_item Evaluate Appreciate|
prepare_{customer} receive_item Evaluate Appreciate|
Evaluate

Evaluate→satisfied|fair|dissatisfied|unsuitable|reject|

check Evaluate|inquire Evaluate|request Evaluate|
dispute_{customer} Evaluate

Settle_{customer}→pay|dispose_{customer}|return_{customer}|

obtain_refund|feedback|Evaluate|
pay Settle_{customer}|dispose_{customer}
Settle_{customer}|return_{customer} Settle_{customer}|
obtain_refund Settle_{customer}|
feedback Settle_{customer}|ε

Attitude→loyal|disloyal|neutral|support Attitude|

dissuade Attitude|ε

Within the meaning of the symbol which appears in a top level production rule “S_{customer}”, “recognize” indicates that the customer recognizes their own needs, “Explore_provider” indicates that the service provider is selected, and “Explore_item” indicates that a service item is selected. In addition, “Consume” indicates the service item is consumed, “Settle_{customer}” indicates that settlement from the customer side, that is, disposing and adjustment are applied, and “Attitude” indicates an attitude after the service provision is received. That is, each symbol (process) is also able to be said to be a framework which indicates a common portion of a variety of services. Here, the customer side process is basically controlled by the customer, but this does not mean that the customer is able to have total control, and for example, there are cases where subsequent customer side processes are restricted according to the selected service provider.

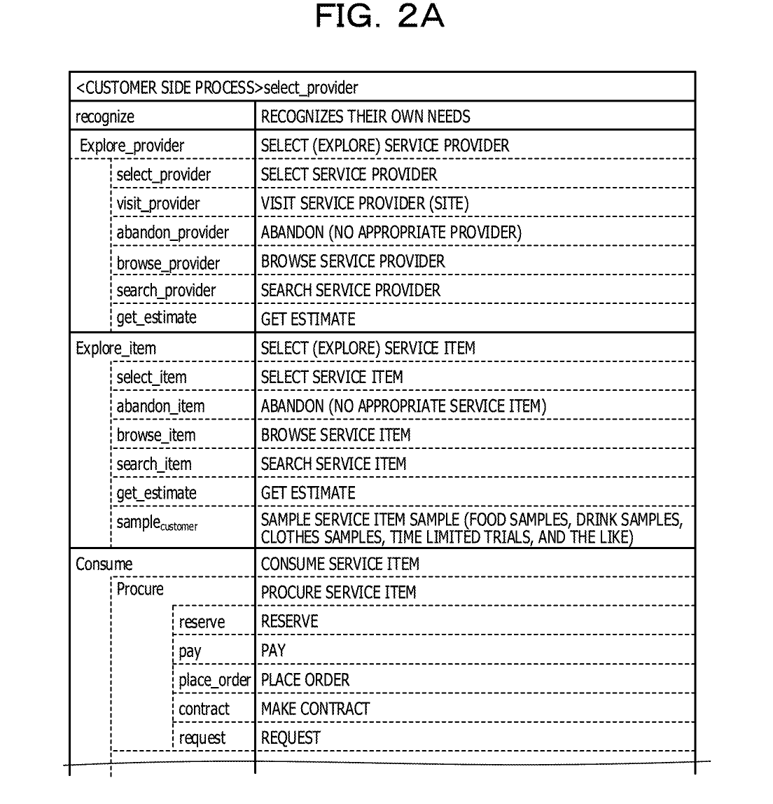

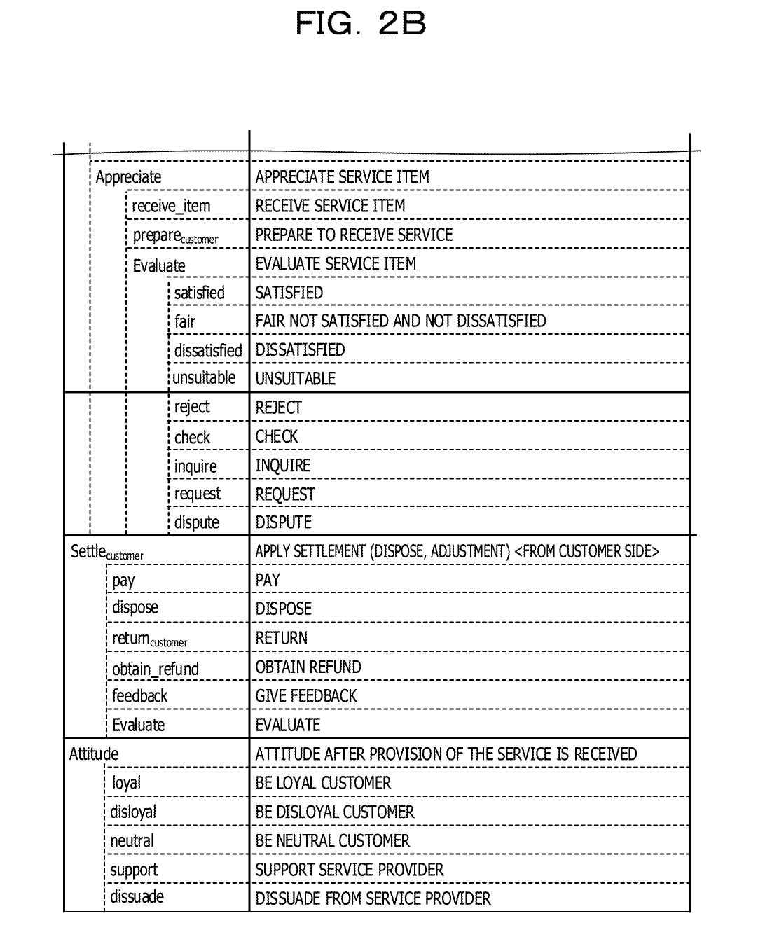

In addition, in the third rule “Explore_provider” of “Consume”, there are cases where the ability to change the provider is ended by the payment with respect to the prior provider. Here, for example, the fourth rule of “Consume” is equivalent to a case such that a menu is selected from a plurality of stores in a food court. In addition, the fifth rule of “Appreciate” is not “receive_item”, but only “Evaluate”, but there are cases where, for example in the manner of rented accommodation, the provision of the initial service item is received and payment is repeated. In addition, on the right side of “Explore_provider”, the left side of “Explore_provider” is included, but “Explore_provider” is repeatedly indicated. Here, other symbols, that is, the meaning of the process is indicated in FIGS. 2A and 2B. FIGS. 2A and 2B are diagrams which describe an example of the meaning of each process on the customer side. FIGS. 2A and 2B illustrate a list of the symbols which appear in the production rules on the customer side, that is, the meaning of the processes, and include the meaning of the low level of a symbol which appears in a top level production rule.

Next, the provider side processes are able to be indicated as follows.

S_{provider}→Arouse Engage Greet Propose Provide Settle_{provider}

Behavioral_review|Arouse Propose Engage Greet Provide
Settle_{provider} Behavioral_review

Arouse→promote|ε
Engage→publicize|advertise|contact|give_estimate|

publicize Engage|advertise Engage|contact Engage|
give_estimate Engage|ε

Greet→welcome|ε
Propose→advertise|recommend|give_estimate|sample_{provider}|

advertise Propose|recommend Propose|
give_estimate Propose|sample_{provider} Propose|ε

Provide→Close-deal Deliver|Close-deal Deliver Propose Provide|

Close-deal Deliver Engage Greet Provide|
Close-deal Deliver Engage Greet Propose Provide|
Close-deal Deliver Propose Engage Greet Provide|ε

Close-deal→accept_reservation|receive_payment|accept_order|

contract_{provider}|respond|
accept_reservation Close-deal|
receive_payment Close-deal|accept_order Close-deal|
contract_{provider} Close-deal|respond Close-deal|ε

Deliver→prepare_{provider} fulfill Assist|

prepare_{provider} fulfill Assist Deliver

Assist→redo|respond|instruct|offer|observe|

dispute_{provider}|respond Assist|instruct Assist|
offer Assist|observe Assist|dispute_{provider} Assist|ε

Settle_{provider}→receive_payment|dispose_{provider}|return_{provider}|

refund|survey|observe|farewell|
bill Settle_{provider}|receive_payment Settle_{provider}|
dispose_{provider} Settle_{provider}|
return_{provider} Settle_{provider}|
refund Settle_{provider}|survey Settle_{provider}|
observe Settle_{provider}|farewell Settle_{provider}|ε

Behavioral_review→research|analyze|

research Behavioral_review|
analyze Behavioral_review|ε

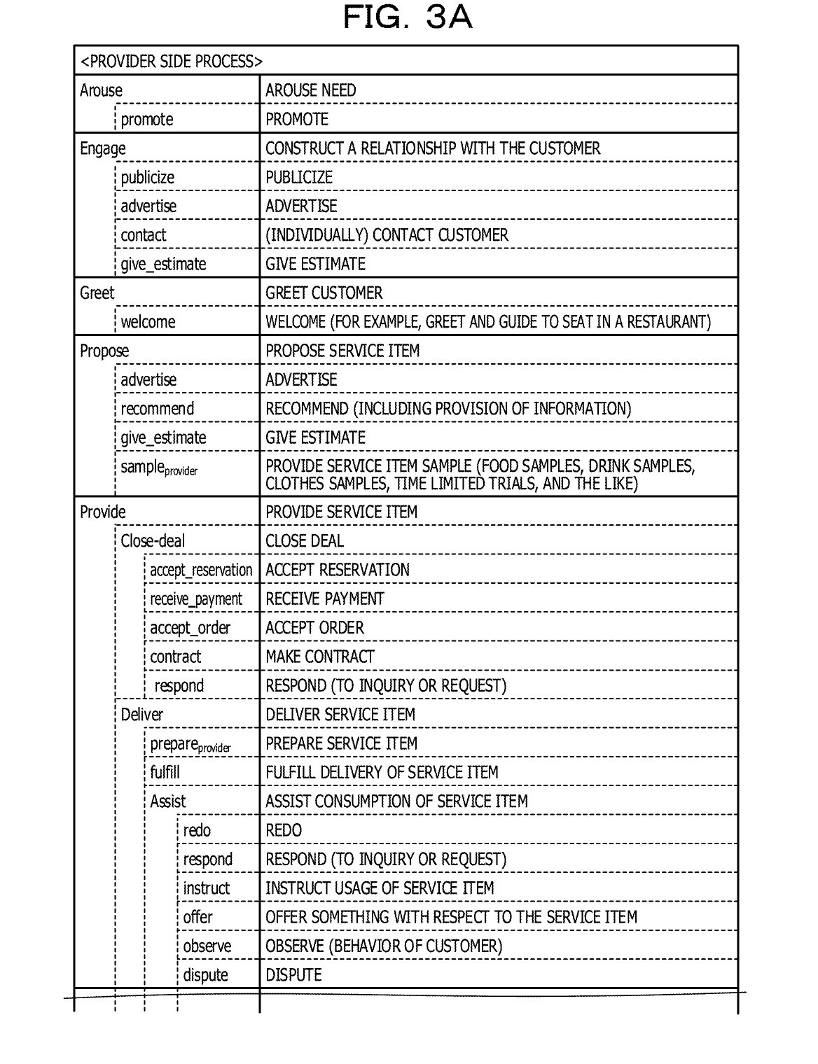

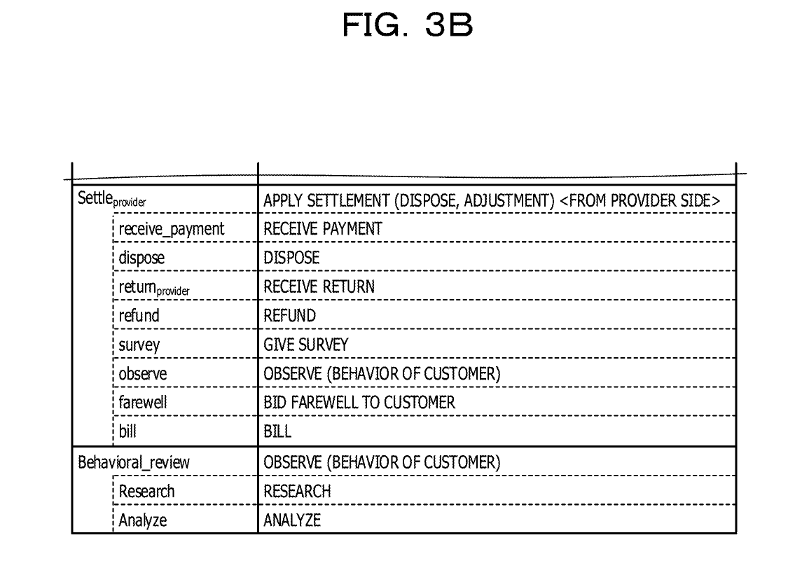

Within the meaning of the symbol which appears in a top level production rule “S_{provider}”, “Arouse” indicates that the needs of the customer are aroused, “Engage” indicates that the provider constructs a relationship with the customer, “Greet” indicates that the customer is greeted, and “Propose” indicates that a service item is proposed. In addition, “Provide” indicates that the service item is provided, “Settle_{provider}” indicates that settlement from the provider side, that is, disposing and adjustment are applied, and “Behavioral_review” indicates that the attitude of the customer is reviewed after the fact. Here, there being no single “bill” on the right side of the production rule “Settle_{provider}” indicates that the “Settle_{provider}” process is not completed using the “bill”. In addition, other symbols, that is, the meaning of the process is indicated in FIGS. 3A and 3B. FIGS. 3A and 3B are diagrams which describe an example of the meaning of each process on the provider side. FIGS. 3A and 3B illustrate a list of the symbols which appear in the production rules on the provider side, that is, the meaning of the process, and include the meaning of the low level of a symbol which appears in a top level production rule.

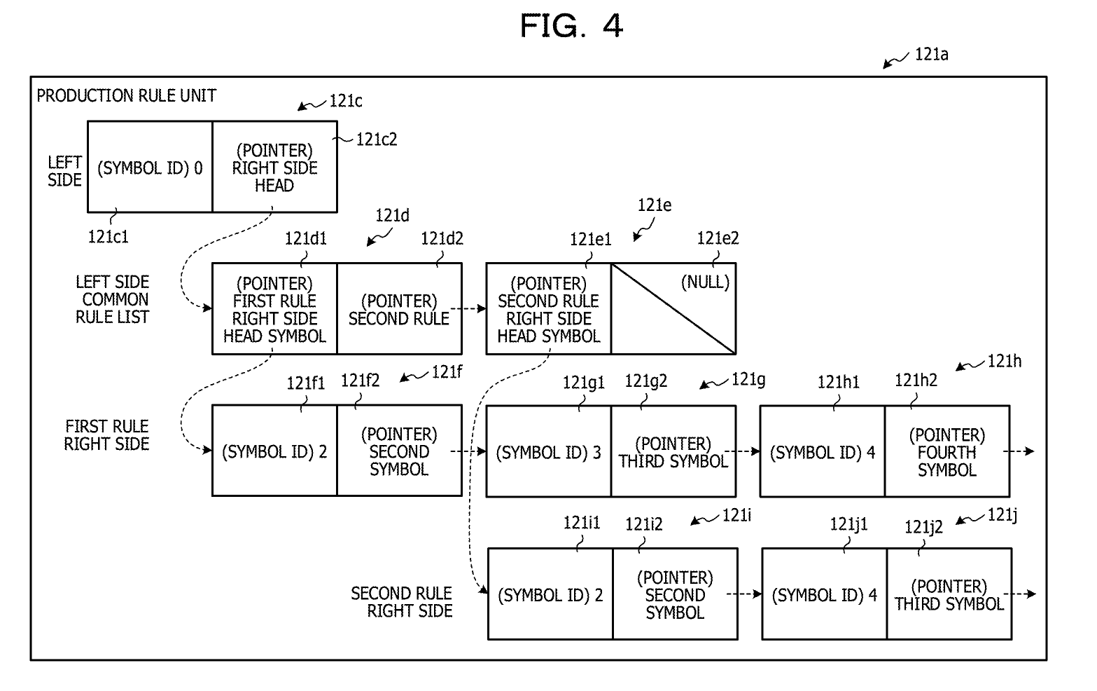

The grammar memory unit 121 has a production rule unit 121a which stores the production rule, and a symbol unit 121b which stores information of each display symbol. FIG. 4 is a diagram illustrating an example of the grammar memory unit. As indicated in FIG. 4, for example, the production rule unit 121a stores the production rule which uses a symbol ID and a pointer which indicates another cell assembly as two cell assemblies. In the example of FIG. 4, a cell assembly 121c indicates the left side of the grammar, and has a cell 121c1 and a cell 121c2. The symbol ID “0” which corresponds to the start symbol S of the context-free grammar is stored in the cell 121c1. The pointer which indicates a head on the right side of the grammar is stored in the cell 121c2. In the example of FIG. 4, the pointer of the cell 121c2 indicates a cell 121d1.

Cell assemblies 121d and 121e indicate a common rule list on the left side. In the example in FIG. 4, there are two cases of the rules. The cell assembly 121d indicates a first rule, and has a cell 121d1 and a cell 121d2. The pointer which indicates a symbol of the head on the right side of the first rule is stored in the cell 121d1. In the example of FIG. 4, the pointer of the cell 121d1 indicates a cell 121f1. The pointer which indicates the second rule is stored in the cell 121d2. The cell assembly 121e indicates the second rule, and has a cell 121e1 and a cell 121e2. The pointer which indicates a symbol of the head on the right side of the second rule is stored in the cell 121e1. In the example of FIG. 4, the pointer of the cell 121e1 indicates a cell 121i1. For example, since there is no third rule, NULL is stored in the cell 121e2.

The cell assemblies 121f, 121g, and 121h indicate the right side of the first rule. The cell assembly 121f indicates a symbol of the head of the first rule, that is, the first symbol, and has a cell 121f1 and a cell 121f2. For example, the symbol ID “2” is stored in the cell 121f1. The pointer which indicates the second symbol is stored in the cell 121f2. A cell assembly 121g indicates the second symbol of the first rule, and has a cell 121g1 and a cell 121g2. For example, a symbol ID “3” is stored in the cell 121g1. The pointer which indicates the third symbol is stored in the cell 121g2.

A cell assembly 121h indicates the third symbol of the first rule, and has a cell 121h1 and a cell 121h2. For example, a symbol ID “4” is stored in the cell 121h1. The pointer which indicates the fourth symbol is stored in the cell 121h2. Here, in the example of FIG. 4, the cell assembly which corresponds to the fourth symbol is omitted hereafter, but has the symbol ID and the pointer in the same manner as the cell assembly 121h.

Cell assemblies 121i and 121j indicate the right side of the second rule. The cell assembly 121i indicates a symbol of the head of the second rule, that is, the first symbol, and has a cell 121i1 and a cell 121i2. For example, the symbol ID “2” is stored in the cell 121i1. The pointer which indicates the second symbol is stored in the cell 121i2. A cell assembly 121j indicates the second symbol of the second rule, and has a cell 121j1 and a cell 121j2. For example, the symbol ID “4” is stored in the cell 121j1. The pointer which indicates the third symbol is stored in the cell 121j2. Here, in the example of FIG. 4, the cell assembly which corresponds to the third symbol is omitted hereafter, but has the symbol ID and the pointer in the same manner as the cell assembly 121j.

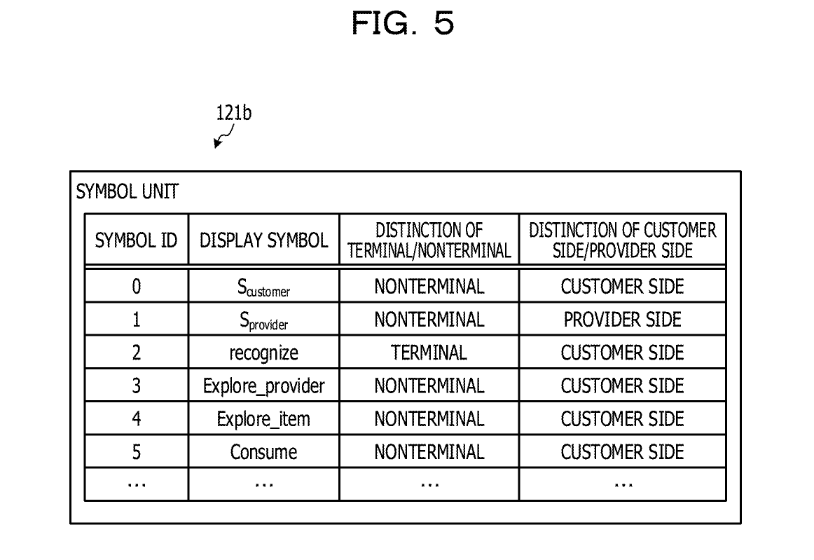

FIG. 5 is a diagram illustrating an example of the grammar memory unit. As indicated in FIG. 5, the symbol unit 121b has items “symbol ID”, “display symbol”, “distinction of terminal/nonterminal”, and “distinction of customer side/provider side”. For example, the symbol unit 121b stores each display symbol as one record.

The “symbol ID” identifies the symbol of context-free grammar, that is, the display symbol of grammar. The “display symbol” indicates the symbol of context-free grammar, that is, the symbol which displays grammar. For example, the display symbol is “S_{customer}” if the start symbol on the customer side, and is “S_{provider}” if the start symbol of the provider side. In addition, for example, the display symbol is a symbol “recognize” which indicates need recognition and “Explore_provider” which indicates selection of the provider. The “distinction of terminal/nonterminal” indicates whether the display symbol is a terminal signal or nonterminal symbol. The “distinction of customer side/provider side” indicates whether the display symbol is on the customer side or on the provider side.

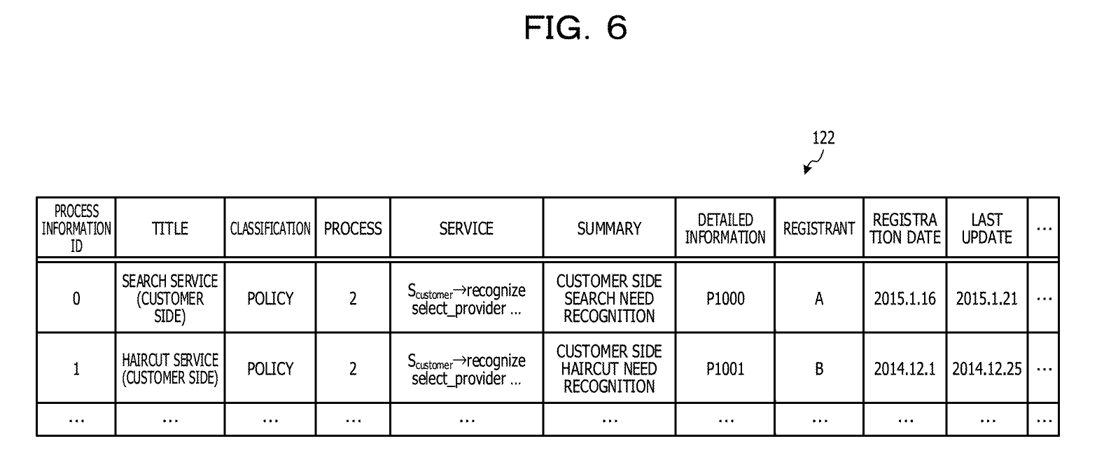

Returning to the description in FIG. 1, the process information DB 122 stores information which is input by the user by associating with the process of the selected grammar. FIG. 6 is a diagram illustrating an example of a process information database. As indicated in FIG. 6, the process information DB 122 has items of “process information ID”, “title”, “classification”, “process”, “service”, “summary”, “detailed information”, “registrant”, “registration date”, and “last update”.

The “process information ID” identifies the information of the service process. The “title” indicates the title of the information. For example, the title is given as “search service (customer side)”. The “classification” indicates the classification of the information. For example, the classification is given as policy, evaluation criteria, findings, know-how, and ideas. The “process” indicates the symbol which is associated with the information, that is, the symbol ID of the process. The “service” indicates specialized service process grammar that corresponds to the service in which the information is produced. The “summary” indicates a summary of the information using text. For example, the summary is given as content of “need recognition on the customer side”. The “detailed information” indicates the pointer of a storage region in which the detailed information is stored. The “registrant” indicates the user for who the information is registered. The “registration date” indicates the day, month, and year when the information was registered. The “last update” indicates the day, month, and year when the information was updated.

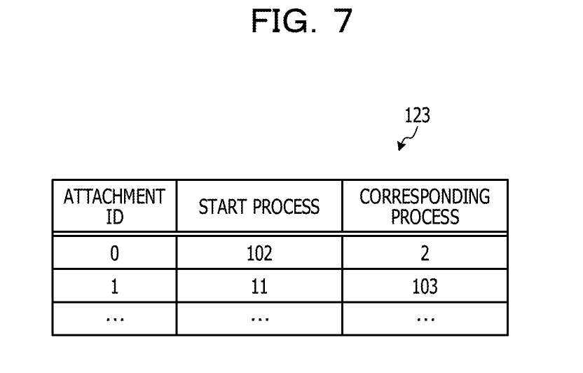

Returning to FIG. 1, the attachment process memory unit 123 stores the attachment information by associating with each process in a case where the customer side process and the provider side process are temporally attached, that is, synchronized. FIG. 7 is a diagram illustrating an example of the attachment process memory unit. As indicated in FIG. 7, the attachment process memory unit 123 has items of “attachment ID”, “start-up process”, and “corresponding process”.

The “attachment ID” identifies attachment between processes. The “start-up process” indicates the symbol ID of the process on the influencing side. The “corresponding process” indicates the symbol ID of the process on the influencing side. In the first example of FIG. 7, a process is set in which a need is aroused that is indicated by a symbol ID “102” using the symbol “Arouse” on the provider side, and a process is set in which the customer recognizes their own needs that is indicated by the symbol ID “2” using the symbol “recognize” on the customer side. At this time, in the first example, “Arouse” and “recognize” are indicated as being attached. That is, the attachment of the symbol ID “102” and “2” indicates contact by the customer and the provider, arousal of the need with respect to the customer from the provider, and the customer recognizing the need. In other words, the attachment of the symbol ID “102” and “2” indicates contact by the customer and the provider, and value is created in unison.

The attachment of the processes is able to be indicated as follows.

Arouse [symbol] recognize
browse_provider [symbol] Engage
get_estimate (Explore_provider) [symbol] give_estimate (Engage)
Engage [symbol] select_provider
visit_provider [symbol] welcome
browse_item [symbol] Propose
search_item [symbol] Propose
get_estimate (Explore_item) [symbol] give_estimate (Propose)
sample_{customer} [symbol] sample_{provider}
Propose [symbol] select_item
reserve [symbol] accept_reservation
pay [symbol] receive_payment
place_order [symbol] accept_order
contract_{customer} [symbol] contract_{provider}
request (Procure) [symbol] respond (Close-deal)
fulfill [symbol] receive_item
inquire [symbol] Assist
request (Evaluate) [symbol] respond (Assist)
Evaluate (Appreciate) [symbol] observe (Assist)
reject [symbol] redo
dispute_{customer} [symbol] dispute_{provider}
bill [symbol] pay (Settle_{customer})
pay (Settle_{customer}) [symbol] receive_payment
return_{customer} [symbol] return_{provider}
refund [symbol] obtain_refund
feedback [symbol] survey
Evaluate (Settle_{customer}) [symbol] observe (Settle_{provider})
Attitude [symbol] Behavioral_review

In the attachment of the processes, a double arrow ( [symbol] ) indicates attachment between processes. That is, the process on the left side of the double arrow (behavior/operation) indicates a process which the customer or the provider starts. The starting of the process requests or induces the process on the right side of the double arrow (behavior/operation). In addition, in the attachment of the processes, a double arrow in both directions ( [symbol] ) indicates that it is possible to start from either. Furthermore, in the description above, even if the processes have the same name, in a case where there is a desire to distinguish according to the process on the left side on the production rule in which the upper level process, that is, the process appears on the right side, the high level process is displayed and distinguished in parentheses.

Returning to the description in FIG. 1, for example, the control unit 130 is realized by a program which is stored inside the storage device executing the RAM as an operation region using a processor such as a central processing unit (CPU) or a micro processing unit (MPU). In addition, for example, the control unit 130 may be realized by an integrated circuit such as an application specific integrated circuit (ASIC) or a field programmable gate array (FPGA). The control unit 130 has a production unit 131, a storage unit 132, and a search unit 133, and realizes or executes a function or action of the information process which is described below. Here, the internal configuration of the control unit 130 is not limited to the configuration which is indicated in FIG. 1, and may be another configuration as long as the configuration performs the information process described later.

The production unit 131 produces the specialized service process grammar, that is, the partial grammar from the generalized service process grammar. For example, when the production unit 131 receives a command in which the specialized service process grammar is produced from the operation unit 112 based on a user operation, the generalized service process grammar is displayed on the display unit 111.

In addition, the production unit 131 receives information on whether there is a production rule that does not correspond to a target service that produces partial grammar from the generalized service process grammar based on operation information which is input from the user. In a case where the production unit 131 receives information on whether there is a production rule that does not correspond to the target service, selection of the production rule that does not correspond to the target service is received. The production unit 131 produces the partial grammar by removing the selected production rule(s) from the generalized service process grammar. In a case where the production unit 131 receives information on whether there is no production rule that does not correspond to the target service, that is, in a case where the grammar is simplified by removing some production rules, and there are no production rules to remove other than the removed production rule(s), the produced partial grammar is stored in the grammar memory unit 121.

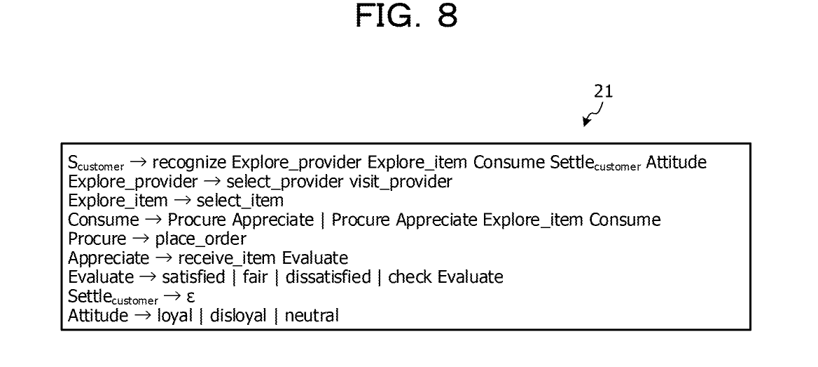

Here, using FIG. 8, an example of the display screen of the partial grammar on the customer side in a state in which the production rule(s) which do not correspond to the target service are removed is described. FIG. 8 is a diagram illustrating an example of the partial grammar display screen. A display screen 21 in FIG. 8 is an example of the display screen of the partial grammar on the customer side in a state in which the production rule(s) which do not correspond to the search service that are selected by the user are removed. The partial grammar of the display screen 21 is short in comparison to the generalized service process grammar described above.

In the case where the production unit 131 removes the selected production rule, the production rule of the nonterminal symbol X includes “X→v” and “X→vX”, and in the service, in a case where a character string v appears only after the process X, “X→v” remains and “X→vX” is removed. In addition, conversely, in a case where the production unit 131 does not end the process X with the character string v, “X→vX” remains and “X→v” is removed. Here, in this case, only in “X→vX”, since the process is not stopped, the process X is in a state in which another production rule remains.

Next, the production unit 131 determines whether or not only one production rule is a nonterminal symbol. In a case where the production rule is not only one nonterminal symbol, the production unit 131 returns the determination of whether or not the production rule does not correspond to the target service. Here, even in a case where the production rule is not only one nonterminal symbol, the production unit 131 may simplify the applied grammar in a case where a method for simplifying the grammar which will be described later is able to be applied.

In a case where there is only one production rule for a nonterminal symbol, the production unit 131 replaces it by the right side of the only one production rule. In addition, the production unit 131 simplifies the grammar. In the case “X→v1|v2| . . . |vn” of the terminal symbol that is the right side which corresponds to the nonterminal symbol, that is, the right side of all production rules, the production unit 131 replaces the nonterminal symbol X by “v1|v2| . . . |vn”.

In the case of the production rules which correspond to the nonterminal symbol are only the two “X→v” and “X→wX”, in a case where the character string v and the character string w are not repeated in the service, only “X→v” remains and the production unit 131 replaces the process X by the character string v. In a case where there is a possibility to repeat the character string v and the character string w in the service, the production unit 131 replaces the process X which is the nonterminal symbol by “w*v” (the character string w is 0 or more and finally the character string v is there). The production unit 131 replaces the process X by “w*” (the character string w is 0 or more) if “X→wX|ε” as the special form of “w*v”. The production unit 131 replaces the process X by “w+” (the character string w is 1 or more) if “X→w|wX” as the special form of “w*v”. The production unit 131 replaces the process X by “w*” (the character string w is 0 or more) if “X→w|wX|ε” with three production rules which correspond to the nonterminal symbols.

In addition, the production unit 131 replaces the process X by “w*(v1|v2| . . . |vn)” from a form where the production rule is “X→v1|v2| . . . |vn|wX (v1, v2, . . . , vn are terminal symbols)”. Furthermore, the production unit 131 replaces the process X by “(w1|w2| . . . |wm)*(v1|v2| . . . |vn)” from a form where the production rule is “X→v1|v2| . . . |vn|w1X|w2X| . . . |wmX (w1, w2, . . . , wm are terminal symbols)”.

In addition, the production unit 131 may further limit “(w1|w2| . . . |wm)*” using information which relates to the service. For example, in a case where the production unit 131 executes only one of the respective processes which correspond to w1, w2, . . . , wm and executes in that order, it is possible to limit “(w1|w2| . . . |wm)*” to “w1 w2 . . . wm”. In addition, in a character string “v1*(v1|v2)”, if the production unit 131 executes only one process which corresponds to the character string v1, it is possible to limit to “v1|(v1 v2)”. “v1 v2?” is also expressed. Here “?” indicates that the character string v2 is optional.

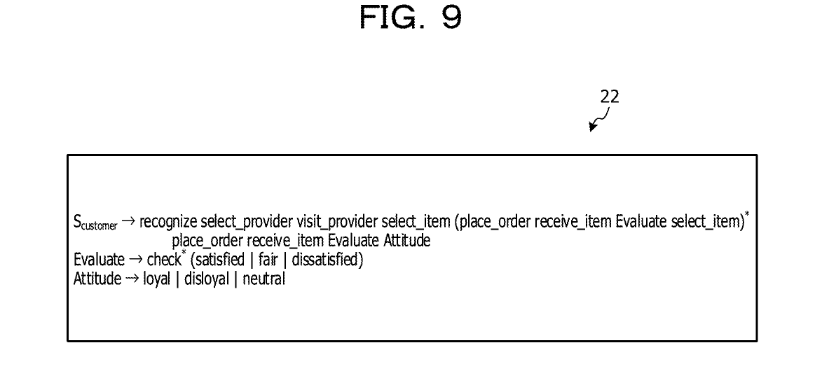

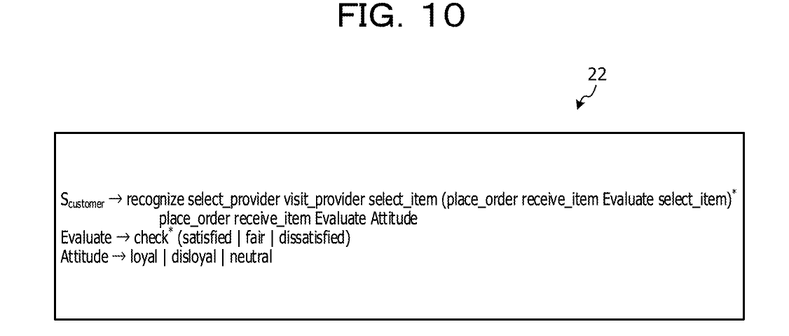

Here, using FIG. 9 and FIG. 10, it is possible to describe an example of the display screen of the partial grammar on the customer side in a state in which the grammar is simplified. FIG. 9 and FIG. 10 are diagrams illustrating another example of a partial grammar display screen. The display screen 22 of FIG. 9 is an example of a display screen of the partial grammar in the state in which simplification of the grammar is performed with respect to the partial grammar on the customer side in a state in which the production rule(s) which do not correspond to the target service are removed. The partial grammar of the display screen 22 is further short in comparison to the partial grammar of the display screen 21 of FIG. 8. A display screen 23 in FIG. 10 has partial grammar in which the partial grammar of the display screen 22 is all combined.

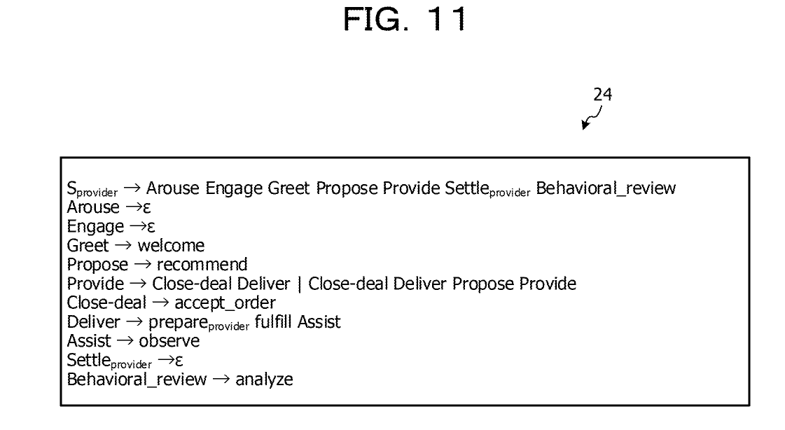

Even in the partial grammar on the provider side, the production unit 131 produces in the same manner as on the customer side. Using FIG. 11, an example of the display screen of the partial grammar on the provider side in a state in which the production rule(s) which do not correspond to the target service are removed is described. FIG. 11 is a diagram illustrating another example of a partial grammar display screen. A display screen 24 in FIG. 11 is an example of the display screen of the partial grammar on the provider side in a state in which the production rule(s) which do not correspond to the search service that are selected by the user are removed. The partial grammar of the display screen 24 is short in comparison to the generalized service process grammar described above.

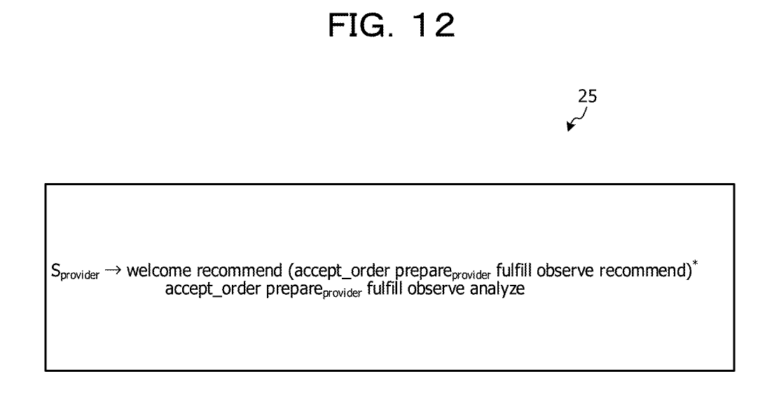

Using FIG. 12, an example of the display screen of the partial grammar on the provider side in a state in which the grammar is simplified is described. FIG. 12 is a diagram illustrating another example of a partial grammar display screen. A display screen 25 of FIG. 12 is an example of a display screen of the partial grammar in the state in which simplification of the grammar is performed with respect to the partial grammar on the provider side in a state in which the production rule(s) which do not correspond to the target service are removed. The partial grammar of the display screen 25 is further short in comparison to the partial grammar of the display screen 24 of FIG. 11.

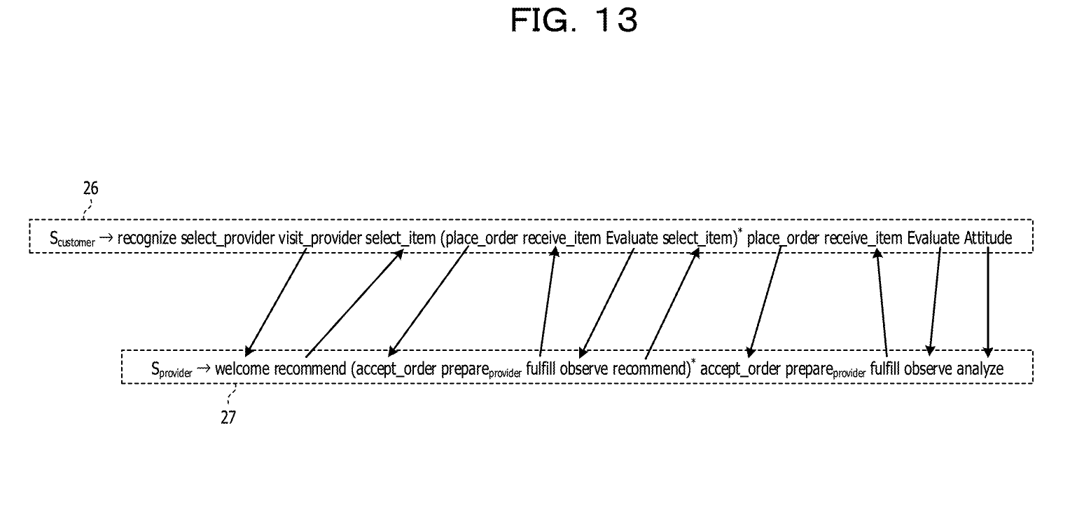

Next, using FIG. 13, attachment of the customer side process and the provider side process in the search service is described. FIG. 13 is a diagram illustrating an example of an attachment process. As indicated in FIG. 13, a customer side process 26 and a provider side process 27 are attached by a process which corresponds to the arrow in the drawings. For example, “visit_provider” of the customer side process 26 is attached to “welcome” of the provider side process 27, that is, the attachment has the meaning of the customer visiting the service provider, and the service provider receiving the customer. Another arrow in FIG. 13 also represents the respective attachment.

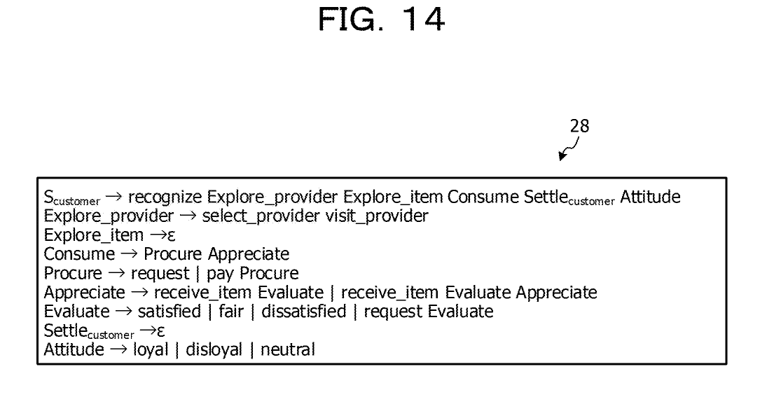

Here, the cases of other services will be described. FIG. 14 to FIG. 19 are diagrams illustrating another example of the partial grammar display screen.

Display screens 28 to 33 which are indicated in FIG. 14 to FIG. 19 are examples of the display screen of the partial grammar in the case of a haircut service. The display screen 28 which is indicated in FIG. 14 is an example of the display screen of the partial grammar on the customer side in a state in which the production rules which do not correspond to the haircut service that are selected by the user are removed. Here, “Procure” not being present on the right side of “request Procure” is because a request which conveys a desired haircut is the rearmost of “Procure”. In addition, because there is no independent “Procure” on the right side of “pay”, “pay” is before “Procure”, that is, not last. The production rules which do not correspond to the target service are removed.

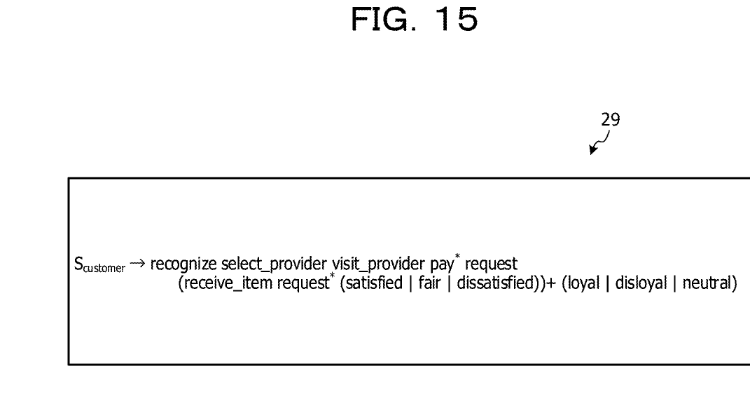

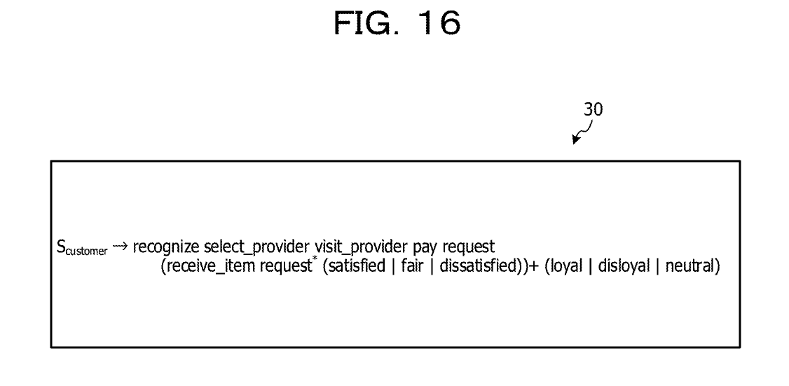

The display screen 29 which is indicated in FIG. 15 is an example of a display screen of the partial grammar in the state in which simplification of the grammar is performed with respect to the partial grammar on the customer side in a state in which the production rules which do not correspond to the target service are removed. Here, as long as “pay” which represents a ticket purchase is only one time, in the manner of the display screen 30 which is indicated in FIG. 16, it is possible to specialize, that is simplify “pay*” to “pay”.

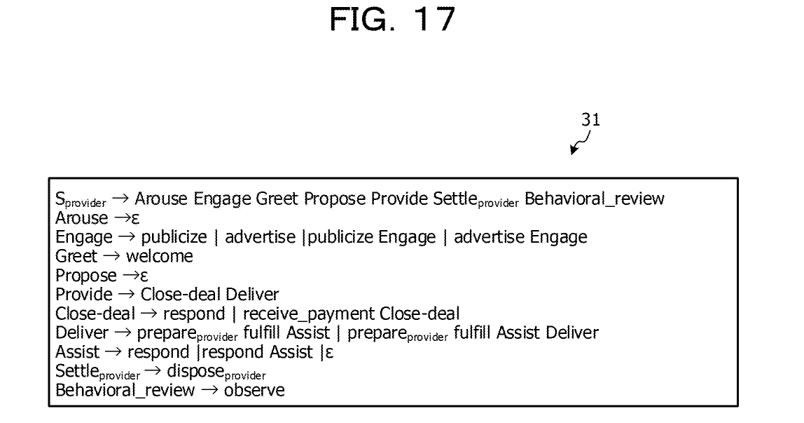

The display screen 31 which is indicated in FIG. 17 is an example of the display screen of the partial grammar on the provider side in a state in which the production rules which do not correspond to the haircut service that are selected by the user are removed. Here, “Close-deal” not being present on the right side of “respond Close-deal” is because responding to a request of receiving the desired haircut is after “Close-deal”. In addition, because there is not an independent “receive_payment” on the right side, “receive_payment” is before “Close-deal”, that is, not after. The production rules which do not correspond to the target service are removed.

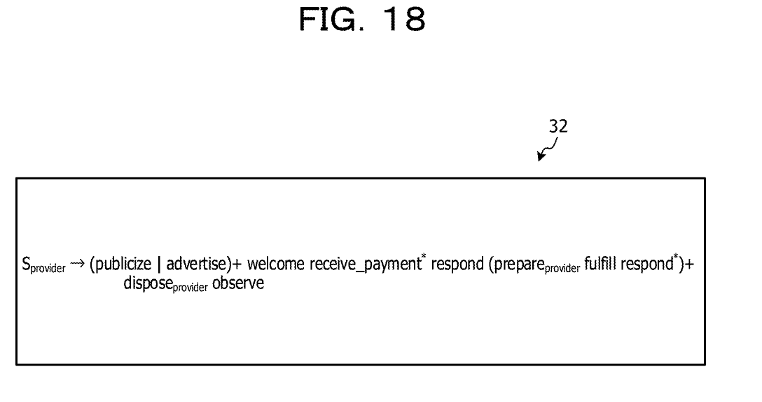

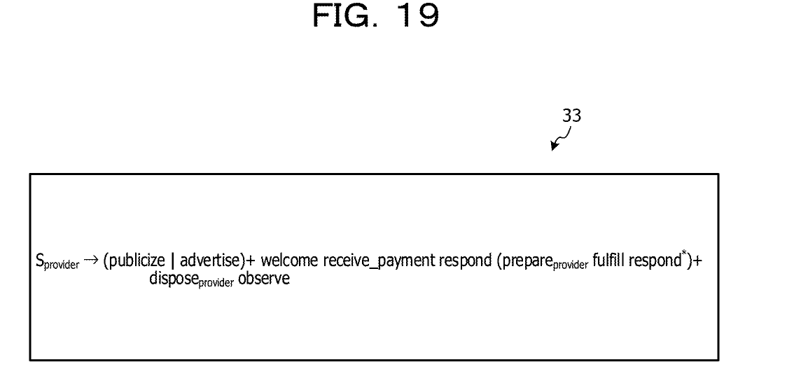

A display screen 32 which is indicated in FIG. 18 is an example of a display screen of the partial grammar in the state in which simplification of the grammar is performed with respect to the partial grammar on the producer side in a state in which the production rules which do not correspond to the target service are removed. Here, as long as “receive_payment” which represents ticket purchase is only once, in the manner of the display screen 33 which is indicated in FIG. 19, it is possible to specialize, that is, simplify “receive_payment*” to “receive_payment”.

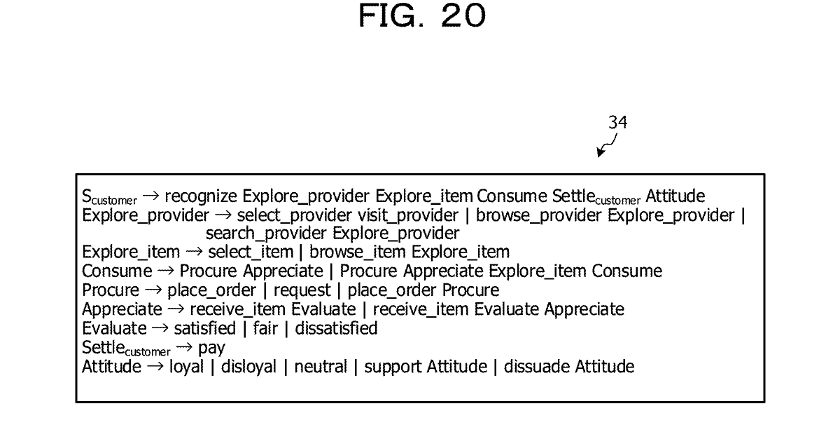

Furthermore, the cases of other services will be described. FIG. 20 to FIG. 25 are diagrams illustrating another example of the partial grammar display screen.

Display screens 34 to 39 which are indicated in FIG. 20 to FIG. 25 are examples of the display screen of the partial grammar in the case of a typical restaurant service. The display screen 34 which is indicated in FIG. 20 is an example of the display screen of the partial grammar on the customer side in a state in which the production rules which do not correspond to the typical restaurant service that are selected by the user are removed. Here, “Procure” not being present on the right side of “request Procure” is because a request which conveys a desired dish is the rearmost of “Procure”. The production rules which do not correspond to the target service are removed.

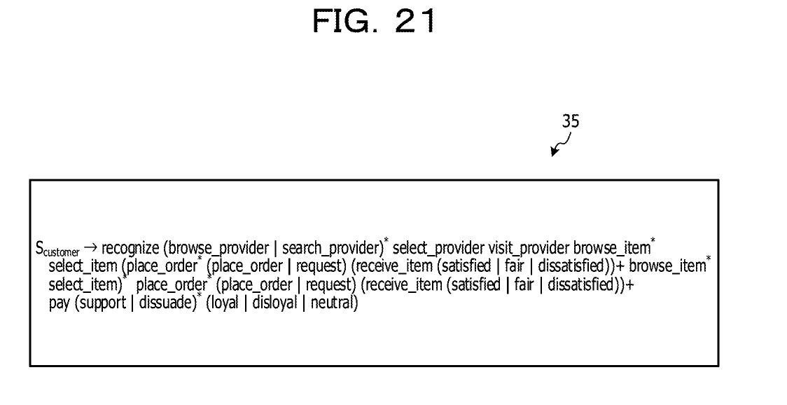

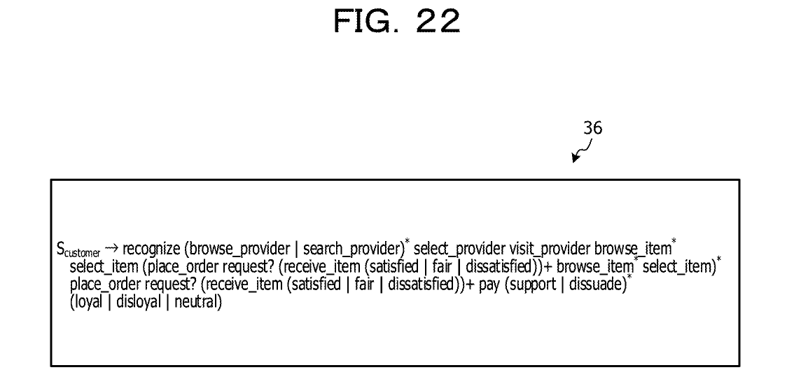

The display screen 35 which is indicated in FIG. 21 is an example of a display screen of the partial grammar in the state in which simplification of the grammar is performed with respect to the partial grammar on the customer side in a state in which the production rules which do not correspond to the target service are removed. Here, as long as “place_order” which represents an order, that is, a dish is only once, in the manner of the display screen 36 which is indicated in FIG. 22, it is possible to specialize, that is, simplify “place_order*(place_order|request)” to “place_order|place_order request” or “place_order request?”.

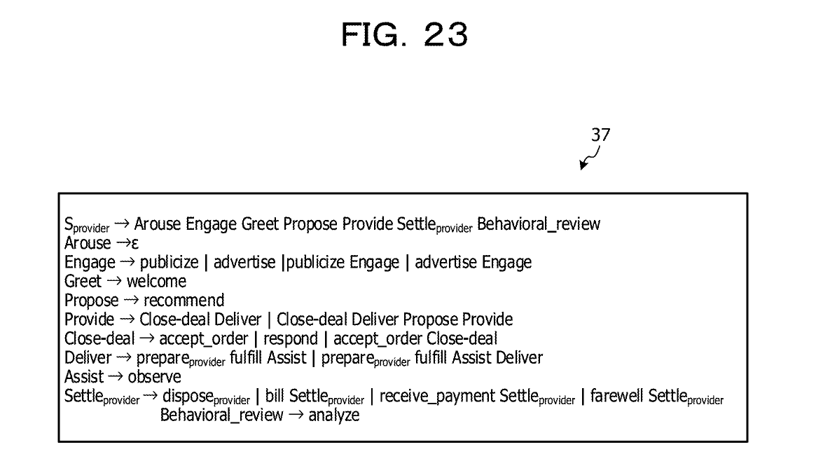

The display screen 37 which is indicated in FIG. 23 is an example of the display screen of the partial grammar on the provider side in a state in which the production rules which do not correspond to the typical restaurant service that are selected by the user are removed. Here, “Close-deal” not being present on the right side of “respond Close-deal” is because responding to a request of receiving the desired dish is after “Close-deal”. In addition, because there is no independent “receive_payment” on the right side of “Settle_{provider}”, “receive_payment” is not after “Settle_{provider}”, that is, “dispose_{provider}” is last. The production rules which do not correspond to the target service are removed.

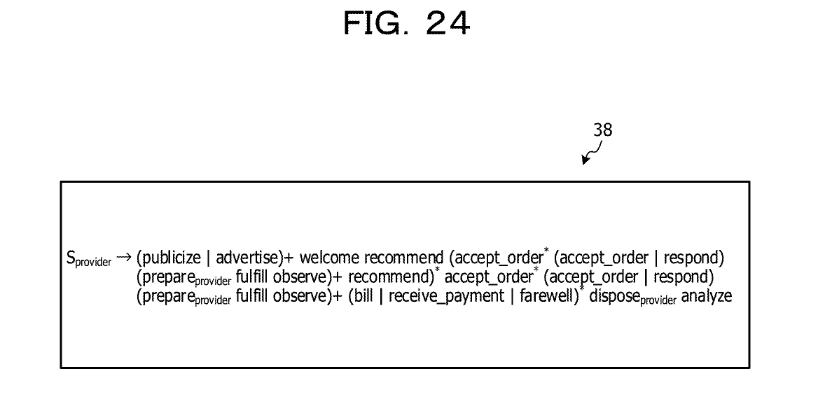

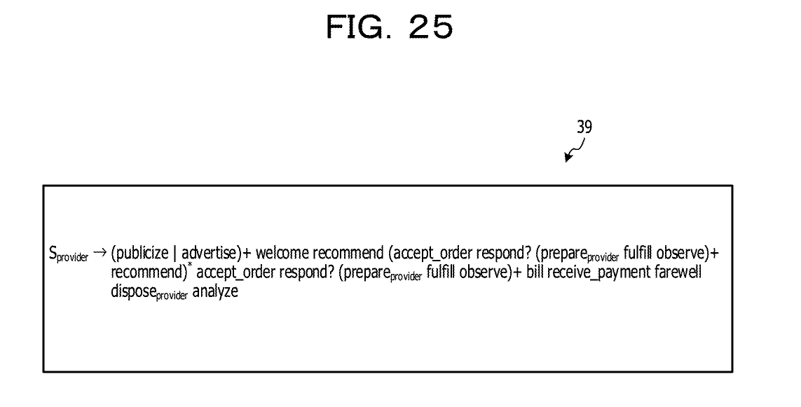

A display screen 38 which is indicated in FIG. 24 is an example of a display screen of the partial grammar in the state in which simplification of the grammar is performed with respect to the partial grammar on the provider side in a state in which the production rules which do not correspond to the target service are removed. Here, as long as “accept_order” which represents receiving an order is only once, in the manner of the display screen 39 which is indicated in FIG. 25, it is possible to specialize, that is, simplify “accept_order*(accept_order|respond)” to “accept_order|accept_order respond” or “accept_order respond?”. In addition, if “bill”, “receive_payment”, and “farewell” are respectively one at a time in the order of “bill”, “receive_payment”, and “farewell”, “(bill|receive_payment|farewell)*” is able to be specialized to “bill receive_payment farewell”.

In addition, the production unit 131 references the grammar memory unit 121 after the partial grammar of the customer side and the provider side services are produced, and the attached processes of the partial grammar on the customer side and the partial grammar on the provider side in each service are extracted. The production unit 131 produces the attachment information which is associated with the start process and the corresponding process concerning the extracted attached processes, and the produced attachment information is stored in the attachment process memory unit 123.

Returning to the description in FIG. 1, the storage unit 132 stores the information which is associated with the process of the specialized or generalized service process grammar. For example, when the storage unit 132 receives a command to store information from the operation unit 112 based on the operation of the user, the specialized or generalized service process grammar is displayed on the display unit 111. Here, in a case where the storage unit 132 stores detailed service information, the specialized service process grammar is displayed on the display unit 111, and in a case where the storage unit 132 stores information which is generally assumed, the generalized service process grammar is displayed on the display unit 111.

The storage unit 132 receives information on whether the process selection in which the information is registered is complete based on operation information which is input from the user. In a case where the storage unit 132 receives notification that the process selection in which the information is registered is not complete, the storage unit 132 receives the process selection in which the information is registered. The storage unit 132 receives input of information which corresponds to the selected process. The storage unit 132 stores the input information in a process information DB 122 which is associated with the process which is selected. When the storage unit 132 stores the input information in the process information DB 122, the storage unit 132 returns to a state of receiving information on whether or not selection of the process in which the information is registered is complete. In a case where the storage unit 132 receives information that the process selection in which the information is registered is complete, the storage unit 132 completes the process in which the information is stored.

The search unit 133 searches the process information DB 122 using a search key by receiving the process as the search key. For example, when the search unit 133 receives a command to search information from the operation unit 112 based on the operation of the user, the specialized or generalized service process grammar is displayed on the display unit 111. Here, in a case where the search unit 133 searches detailed service information, the specialized service process grammar is displayed on the display unit 111, and in a case where the search unit 133 searches information which is generally assumed, the generalized service process grammar is displayed on the display unit 111.

The search unit 133 receives the searched process, that is, the search key selection from the processes of the displayed grammar. When the search unit 133 receives the search key selection, the search unit 133 receives information on whether or not the search key is extended based on the operation information which is input from the user. In a case where the search unit 133 receives the extension of the search key selection, the search unit 133 receives information on whether or not the attachment information is used based on the operation information which is input from the user.

In a case where the search unit 133 receives using the attachment information, the search unit 133 refers to the attachment process memory unit 123, and extends the search key using the attachment information. In a case where the search unit 133 receives without using the attachment information, the search unit 133 extends the search key using a high level process of the search key process. That is, the search unit 133 searches using a more general key. The search unit 133 searches the process information DB 122 using the extended search key. Here, in a case where the search unit 133 receives without extension of the search key, the search unit 133 searches the process information DB 122 using the search key without extending the search key.

The search unit 133 determines whether or not the number of the search result is a predetermined value or more. Here, the predetermined value is able to be an arbitrary value, and for example, it is possible for the number to be set as 1, 2, 3, 4, 5, 10, or the like. In a case where the number of the search result is the predetermined value or less, the search unit 133 receives information on whether or not the search result is displayed based on the operation information which is input from the user. In a case where the search unit 133 receives the display of the search result, the search result is displayed on the display unit 111. In a case where the search unit 133 receives without displaying the search result, the search unit 133 returns to a state of receiving information on whether or not the search key is extended.

In a case where the number of the search result is greater than the predetermined value, the search unit 133 receives information on whether or not the search result is refined by process similarity based on the operation information which is input from the user. In a case of receiving by refining the search result by process similarity, the search unit 133 refines the search result by process similarity and displays the refined search result on the display unit 111. In a case of receiving without refining the search result by process similarity, the search unit 133 displays the search result on the display unit 111 without refining by process similarity.

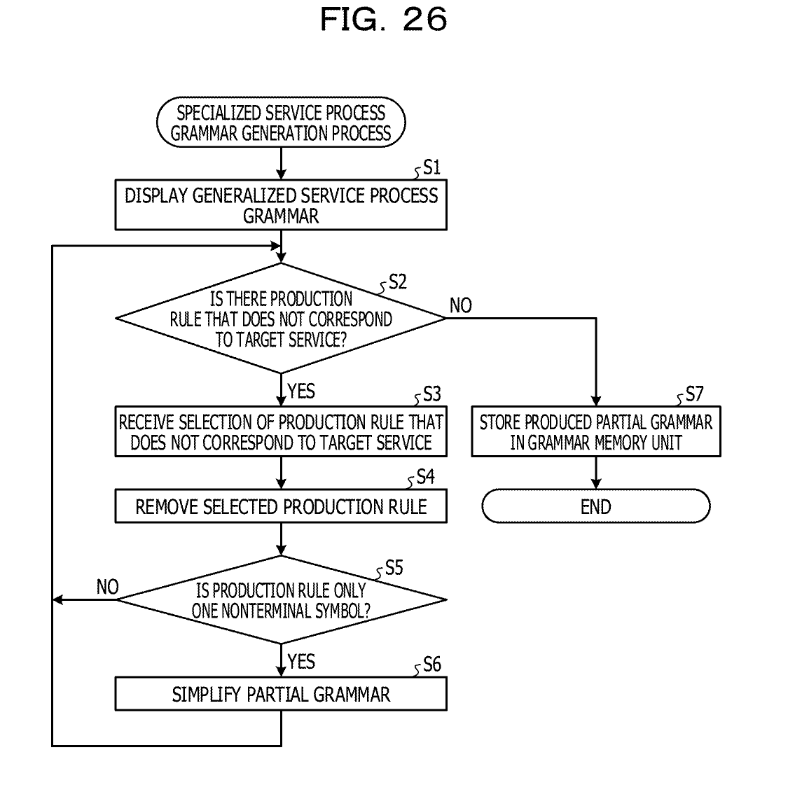

Next, operations of the information management device of the embodiment will be described. First, concerning the service, the specialized service process grammar production process in which specialized service process grammar, that is, partial grammar is produced. FIG. 26 is a flow chart illustrating an example of the specialized service process grammar generation process.

For example, when the production unit 131 receives a command in which the specialized service process grammar is produced from the operation unit 112 based on a user operation, the generalized service process grammar is displayed on the display unit 111 (step S1). The production unit 131 receives information on whether or not there is a production rule that does not correspond to the target service that produces partial grammar from the generalized service process grammar based on operation information which is input from the user (step S2). In a case where the production unit 131 receives information that there is a production rule that does not correspond to a target service (step S2: YES), selection of the production rule that does not correspond to the target service is received (step S3).

The production unit 131 produces the partial grammar by removing the selected production rule(s) from the generalized service process grammar (step S4). The production unit 131 determines whether or not the production rule for the partial grammar is only one nonterminal symbol (step S5). In the production unit 131, in a case where the production rule is not only one nonterminal symbol (step S5: NO), the process returns to step S2. In a case where the production rule is only one nonterminal symbol (step S5: YES), the production unit 131 simplifies the partial grammar by replacing the nonterminal symbol by the right side of the production rule (step S6), and the process returns to step S2. In addition, in a case where the replacing of the partial grammar described above is also possible elsewhere, the production unit 131 simplifies the partial grammar by performing replacing.

In a case where the production unit 131 receives without the production rule that does not correspond to the target service (step S2: NO), the produced partial grammar is stored in the grammar memory unit 121 (step S7), and the specialized service process grammar generation process is complete. Thereby, the information management device 100 is able to produce the specialized service process grammar which corresponds to various services.

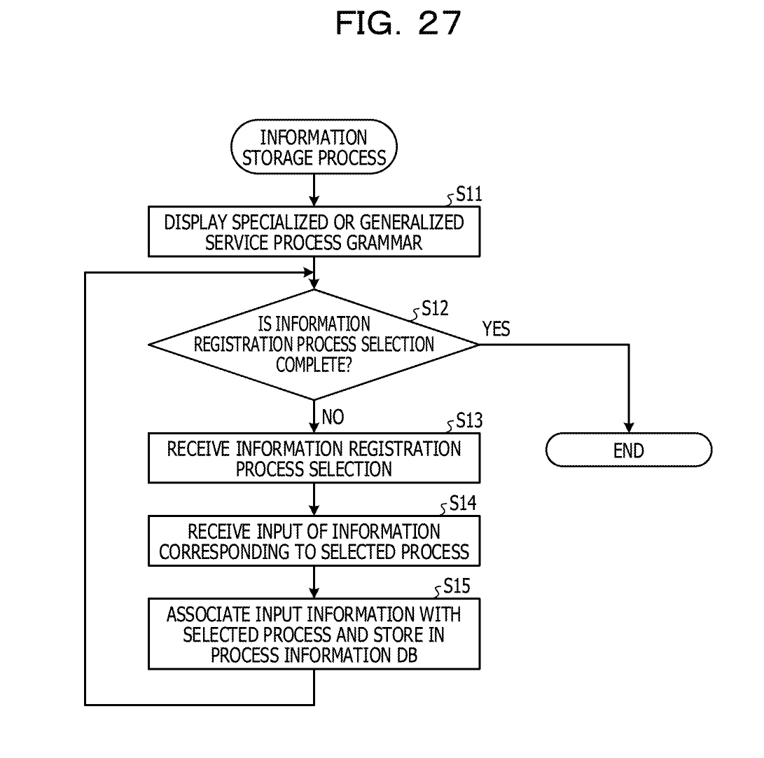

Next, the information storage process in which information is stored by associating with the specialized or generalized service process grammar will be described. FIG. 27 is a flow chart illustrating an example of the information storage process.

For example, when the storage unit 132 receives a command to store information from the operation unit 112 based on the operation of the user, the specialized or generalized service process grammar is displayed on the display unit 111 (step S11). The storage unit 132 receives information on whether the process selection in which the information is registered is complete based on operation information which is input from the user (step S12). In a case where the storage unit 132 receives information that the process selection in which the information is registered is not complete (step S12: NO), the storage unit 132 receives the process selection in which the information is registered (step S13).

The storage unit 132 receives input of information which corresponds to the selected process (step S14). The storage unit 132 stores the input information in the process information DB 122 which is associated with the process which is selected (step S15). When the storage unit 132 stores the input information in the process information DB 122, the process returns to step S12. In a case where the storage unit 132 receives information that the process selection in which the information is registered is complete (step S12: YES), the information storage process ends. Thereby, the information management device 100 is able to store by associating the information in the process of the specialized or generalized service process grammar.

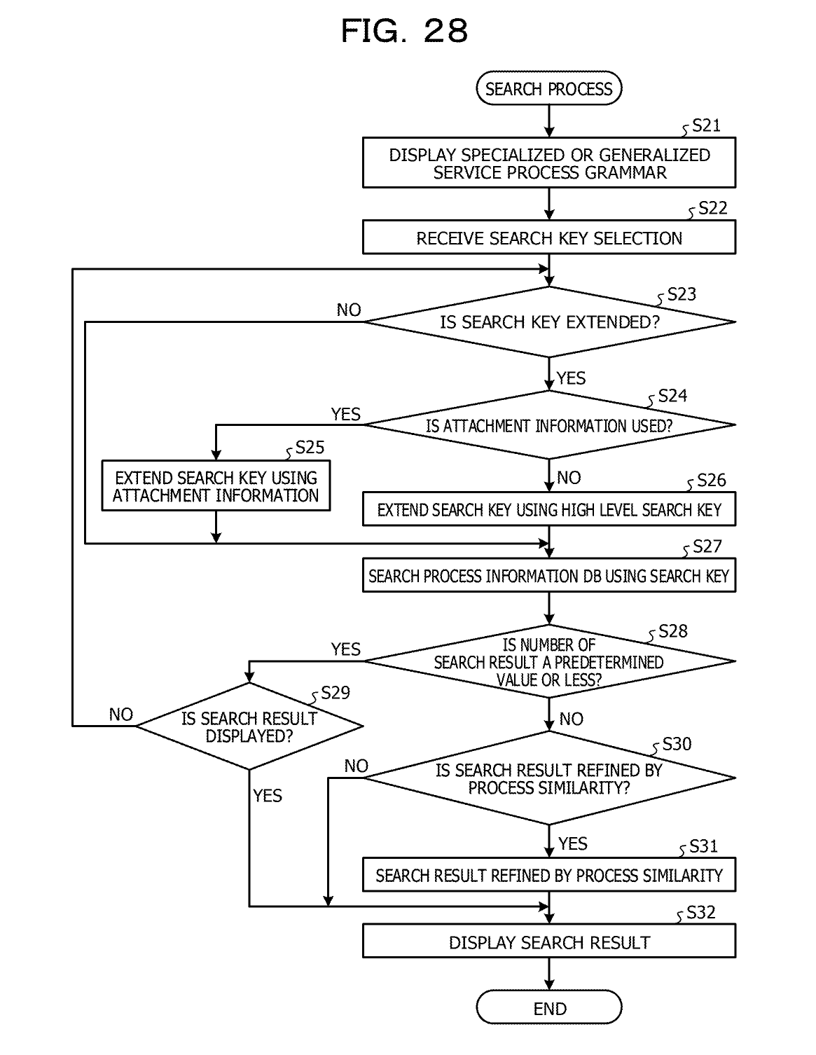

Next, the search result in which the process information DB 122 is searched using the search key will be described. FIG. 28 is a flow chart illustrating an example of a search process.

For example, when the search unit 133 receives a command to store information from the operation unit 112 based on the operation of the user, the specialized or generalized service process grammar is displayed on the display unit 111 (step S21). The search unit 133 receives the search key selection which is a search process from the processes of the displayed grammar (step S22). When the search unit 133 receives the search key selection, the search unit 133 receives information on whether or not the search key is extended based on the operation information which is input from the user (step S23). In a case where the search unit 133 receives the extension of the search key selection (step S23: YES), the search unit 133 receives information on whether or not the attachment information is used based on the operation information which is input from the user (step S24).

In a case where the search unit 133 receives using the attachment information (step S24: YES), the search unit 133 refers to the attachment process memory unit 123, and extends the search key using the attachment information (step S25). In a case where the search unit 133 receives without using the attachment information (step S24: NO), the search unit 133 extends the search key using a high level process of the search key process (step S26). The search unit 133 searches the process information DB 122 using the extended search (step S27). In addition, in a case where the search unit 133 receives without extension of the search key (step S23: NO), the search unit 133 searches the process information DB 122 using the search key without extending the search key (step S27).

The search unit 133 determines whether or not the number of the search result is a predetermined value or less (step S28). In a case where the number of the search result is the predetermined value or less (step S28: YES), the search unit 133 receives information on whether or not the search result is displayed based on the operation information which is input from the user by notifying the number of the search result to the user (step S29). In a case where the search unit 133 receives the display of the search result (step S29: YES), the search result is displayed on the display unit 111 (step S32). In a case where the search unit 133 receives the without displaying the search result (step S29: NO), the process returns to step S23.

In a case where the number of the search result is greater than the predetermined value (step S28: NO), the search unit 133 receives information on whether or not the search result is refined by process similarity based on the operation information which is input from the user (step S30). In a case of refining the search result by process similarity (step S30: YES), the search unit 133 refines the search result by process similarity (step S31), and displays the refined search result on the display unit 111 (step S32). In a case of receiving without refining the search result by process similarity (step S30: NO), the search unit 133 displays the search result on the display unit 111 without refining the search result by process similarity (step S32). Thereby, the information management device 100 is able to search information on various services which include a time series process using general vocabulary.

In the same manner, the information management device 100 displays the first service process which is defined by a process of a service with context-free grammar. In addition, the information management device 100 produces a second service process which includes a production rule which corresponds to a service which is selected from the production rules of the displayed first service process, and corresponds to the service. In addition, the information management device 100 stores by associating with information in a process which is included in the produced second service process in the memory unit. As a result, it is possible to search service information which includes a time series process. That is, even in a case where the industry and business category of the services are different, the information management device 100 is able to mutually perform sharing and reuse of the respective information. In other words, the information management device 100 is able to make it possible to innovate and raise the level of the service using comprehensive information about similar services. In addition, the information management device 100 is able to connect words which are different according to the industry and business category using the vocabulary of the generalized service process grammar. In addition, the information management device 100 is able to teach the industry and business category which appear to be separate in reality or close to from the viewpoint of the process according to the similarity of the grammar. Furthermore, the information management device 100 is able to systematically compare and analyze various services from the viewpoint of commonality of the generalized service process.

In addition, the information management device 100 produces the second service process by selecting the production rule of the displayed first service process to the user. As a result, it is possible to produce the second service process according to the service.

In addition, the information management device 100 produces the second service process respectively for the services on the customer side and on the provider side. As a result, since contact between the customer and the provider is expressed on both of the customer side and the provider side, it is possible to search the information which relates to the value which is co-created by the customer and the provider coming in contact.

In addition, the information management device 100 produces the second service process which includes repeating the process. As a result, the second service process is able to describe the service process in more detail using the characteristics of the process flow which includes repetition.

In addition, in the information management device 100, the information is information of one or more of policy, evaluation criteria, findings, know-how, and ideas. As a result, even in a case where the industry and business category of the services are different, it is possible to mutually perform sharing and reuse of the information which is one or more of policy, evaluation criteria, findings, know-how, and ideas.

In addition, the information management device 100 further includes the search unit which searches the memory unit using a character string which specifies the process that is included in the first service process. As a result, it is possible to search the service using a phrase in which the service process is a high level concept.

In addition, the information management device 100 produces the second service process which includes the production rule which corresponds to a service that is selected from the production rules of the displayed first service process, and corresponds to the service. As a result, it is possible to search service information which includes a time series process.

Here, in the embodiment, the information management device 100 is described as an aspect which the user operates, but is not limited thereto. For example, the information management device 100 may be provided to function on a server or the cloud. In this case, the user may be given access to the information management device 100 from a terminal device via a network, associate information with production of the specialized service process grammar or a process of the grammar, and perform a search on the information in which vocabulary of the generalized service process grammar is used. That is, the terminal device which is operated by the user has the same functions as the display unit 111 and the operation unit 112 of the information management device 100. Here, in a case where the information management device 100 is provided to function on a server or the cloud, it is possible to configure the information management device 100 to have a communication unit for communicating with the network.

In addition, in the embodiment, the partial grammar is produced by removing the production rule(s) which do not correspond to the target service, but is not limited thereto. For example, the partial grammar may be produced by the user selecting the production rule which corresponds to the target service.

In addition, each configuration element of each unit which is illustrated does not necessarily have to be physically configured as illustrated. That is, the specific mode of dispersion and integration of each unit is not limited to the illustration, and it is possible to configure the entirety or a portion functionally or physically dispersed or integrated in arbitrary units according to various loads, usage conditions, and the like. For example, a process in which the grammar in the production unit 131, the storage unit 132, and the search unit 133 is displayed may be split as a display control unit.

Furthermore, various process functions which are performed by each device may be executed by the entirety or an arbitrary portion on the CPU (or a micro computer such as the MPU or a micro controller unit (MCU)). In addition, of course various process functions may be executed by the entirety or an arbitrary portion on a program which executes analysis using the CPU (or a micro computer such as the MPU or the MCU), or on hardware using wired logic.

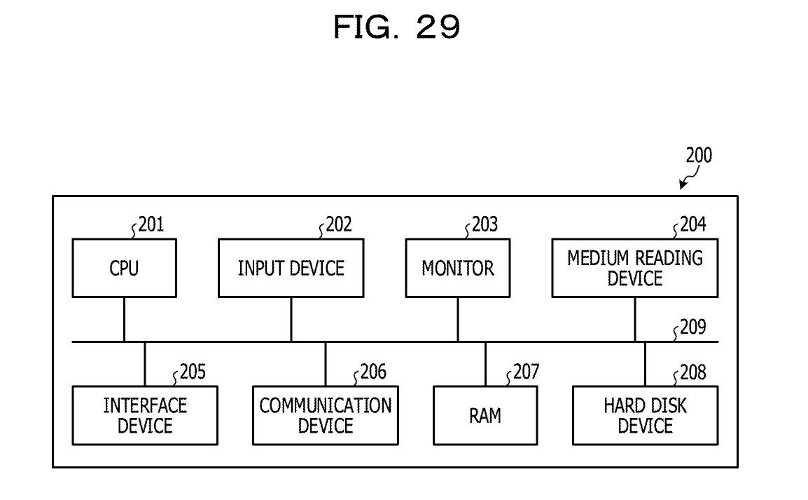

Here, various processes which are described in the embodiment above are able to be realized by executing a program prepared in advance using a computer. Therefore, an example of the computer which executes the program that has the same function as the embodiment above will be described below. FIG. 29 is a diagram illustrating an example of a computer which executes an information management program.

As indicated in FIG. 29, a computer 200 has a CPU 201 which executes various arithmetic processes, an input device 202 which receives data input, and a monitor 203. In addition, the computer 200 has a medium reading device 204 which reads a program or the like from a storage medium, an interface device 205 for connecting various devices, and a communication device 206 for connecting wiredly or wirelessly to other information processing devices and the like. In addition, the computer 200 has a RAM 207 which temporarily stores various information, and a hard disk device 208. In addition, each device 201 to 208 is connected to a bus 209.

An information processing program which functions in the same manner as each processing unit of the production unit 131, the storage unit 132, and the search unit 133 which are indicated in FIG. 1 is stored on the hard disk device 208. In addition, various data is stored on the hard disk device 208 in order to realize the grammar memory unit 121, the process information DB 122, the attachment process memory unit 123, and the information management program. For example, the input device 202 functions in the same manner as the operation unit 112 which is indicated in FIG. 1 and receives input of various information of operation information and the like from the user. For example, the monitor 203 functions in the same manner as the display unit 111 which is indicated in FIG. 1 and displays a display screen and various screens with respect to the user. For example, the interface device 205 is connected by a printing apparatus or the like. For example, the communication device 206 is a communication unit, is connected to a network which is not indicated in the drawings, and exchanges with various devices and various information.

The CPU 201 performs various processes by reading each program which is stored on the hard disk device 208, and executing expansion in the RAM 207. In addition, the programs are able to cause the computer 200 to function as the production unit 131, the storage unit 132, and the search unit 133 which are indicated in FIG. 1.

Here, the display control programs do not necessarily have to be stored on the hard disk device 208. For example, the program which is stored on a recording medium so as to be readable by the computer 200 may be executed by reading by the computer 200. For example, the recording medium which is readable by the computer 200 corresponds to a portable storage medium such as a CD-ROM, a DVD disc, a Universal Serial Bus (USB) memory and the like, a semiconductor memory such as a flash memory, a hard disk drive, and the like. In addition, the information management program may be stored in a device which is connected to a public network, the Internet, LAN, or the like, and from these the computer 200 may execute by reading the information management program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information management device comprising:
a memory; and
a processor coupled to the memory and configured to:
produce a second service process of a service which is defined by partial grammar by removing a first production rule out of a plurality production rules which are used by a first service process defined by context-free grammar, the first production rule being selected from among the plurality of production rules, and
store process information associated with input information into the memory, the process information indicating a process included in the second service process.

2. The information management device according to claim 1, wherein
the processor is configured to receive an input of a selection of the first production rule from among the plurality of production rules of the first service process, and
the second service process is produced based on the input.

3. The information management device according to claim 1,
wherein the processor is configured to produce the second service process respectively on a customer side and a provider side of the service.

4. The information management device according to claim 2,
wherein the processor is configured to produce the second service process respectively on a customer side and a provider side of the service.

5. The information management device according to claim 1,
wherein the processor is configured to produce the second service process which includes repeating the process.

6. The information management device according to claim 2,
wherein the processor is configured to produce the second service process which includes repeating the process.

7. The information management device according to claim 1,
wherein the input information is information of one or more of policy, evaluation criteria, findings, know-how, and ideas.

8. The information management device according to claim 1,
wherein the processor is configured to search the memory using a character string that specifies another process which is included in the first service process.

9. The information management device according to claim 2,
wherein the processor is configured to search the memory using a character string that specifies another process which is included in the first service process.

10. The information management device according to claim 3,
wherein the processor is configured to search the memory using a character string that specifies another process which is included in the first service process.

11. The information management device according to claim 1,
wherein the processor is configured to produce the second service process which includes only second production rule, from among the plurality of production rules of the first service process, which is suitable for the service which is selected.

12. The information management device according to claim 2,
wherein the processor is configured to produce the second service process based on only second production rule, from among the plurality of production rules of the first service process, which is suitable for the service which is selected.

13. The information management device according to claim 3,
wherein the processor is configured to produce the second service process based on only second production rule, from among the plurality of production rules of the first service process, which is suitable for the service which is selected.

14. An information management method executed by a computer, method, the information management comprising:
producing a second service process of a service which is defined by partial grammar by removing a first production rule out of a plurality production rules which are used by a first service process defined by context-free grammar, the first production rule being selected from among the plurality of production rules; and
storing process information associated with input information into a memory, the process information indicating a process included in the second service process.

15. The information management method according to claim 14, wherein
the producing receives an input of a selection of the first production rule from among the plurality of production rules of the first service process, and
the second service process is produced based on the input.

16. The information management method according to claim 14,
wherein the producing produces the second service process respectively on a customer side and a provider side of the service.

17. The information management method according to claim 14,
wherein the producing produces the second service process which includes repeating the process.

18. The information management method according to claim 14,
wherein the input information is information of one or more of policy, evaluation criteria, findings, know-how, and ideas.

19. The information management method according to claim 14, further comprising:
searching the memory unit using a character string that specifies another process which is included in the first service process.

20. A non-transitory storage medium storing an information management program which causes a computer to execute a procedure, the procedure comprising:
producing a second service process of a service which is defined by partial grammar by removing a first production rule out of a plurality production rules which are used by a first service process defined by context-free grammar, the first production rule being selected from among the plurality of production rules; and
storing process information associated with input information into a memory, the process information indicating a process included in the second service process.
